(19) United States
(12) Patent Application Publication
(10) Pub. No.: US 2005/0124379 A1
(43) Pub. Date: Jun. 9, 2005

(54) [PORTABLE COMMUNICATION DEVICE]

(76) Inventor: REN-HAO LIU, TAIPEI (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,173

(22) Filed: Feb. 13, 2004

(30) Foreign Application Priority Data
Dec. 4, 2003 (TW) 92134144

(51) Int. Cl. H04M 1/00

(52) U.S. Cl. 455/556.1; 455/575.1

(57) ABSTRACT

A portable communication device comprising a casing, a host module, a wireless communication module, an image-capturing unit, a man-machine interface, a first connecting port and a flash lamp is provided. The host module is installed within the casing. The wireless communication module is installed within the casing and electrically coupled to the host module. The wireless communication module is used to receive/transmit a communication signal. The image-capturing unit, the man-machine interface and the first connecting port are mounted on the casing and electrically coupled to the host module. The image-capturing unit is used to capture an optical image. The man-machine interface is used to control the host module. The flash lamp is a light source. The flash lamp has a second connecting port with a removable electrical connection to the first connecting port.

### BACKGROUND OF INVENTION

1. Field of the Invention

The present invention relates to a portable communication device. More particularly, the present invention relates to a portable communication device having an externally connected flash lamp.

2. Description of the Related Art

In this information explosion era, electronic communication has become indispensable. People rely heavily on electronic devices to transmit messages. With the invention of portable devices such as cellular phone or other wireless communication devices, portable communication is even more popular.

As innovative manufacturing techniques continue to be discovered, additional functions are added to a cellular phone. Aside from receiving broadcast, many types of cellular phone are now provided with a camera. Through a wireless communication service system, a user may capture a digital image of a particular scene using a portable phone and then transmit the image to another person. In this way, users may capture images and transmit the images to remote users through their cellular phones.

Although most conventional cellular phone has a camera, insufficient illumination or inappropriate light setting often results in poorly captured images. When the picture quality of the captured image is poor, the desire for purchasing a cellular phone with photographic function may drop. Therefore, improving the quality of images captured by a cellular phone with photographic function is important to stimulate customers' desire for the product.

### SUMMARY OF INVENTION

Accordingly, at least one objective of the present invention is to provide a portable communication device having an additional light source for taking pictures without increasing the weight or volume of the device.

To achieve these and other advantages and in accordance with the purpose of the invention, as embodied and broadly described herein, the invention provides a portable communication device. The portable communication device comprises a casing, a host module, a wireless communication module, an image-capturing unit, a man-machine interface (MMI), a first connecting port and a flash lamp. The host module is installed within the casing. The wireless communication module is installed within the casing and electrically coupled to the host module. The wireless communication module is used to receive/transmit a communication signal. The image-capturing unit, the man-machine interface and the first connecting port are mounted on the casing and electrically coupled to the host module. The image-capturing unit is used to capture an optical image. The man-machine interface is used to control the host module. The flash lamp has a second connecting port with a removable electrical connection to the first connecting port. The flash lamp provides light for taking pictures.

According to the embodiment of the present invention, the flash lamp further comprises a power source. Alternatively, the first connecting port has a power output terminal and the second connecting port has another power input terminal for contacting the power input terminal of the first connecting port.

The aforementioned man-machine interface further comprises an instruction-input unit and an image output unit. The instruction-input unit and the image output unit may be integrated together to form a touch-control screen. Furthermore, the man-machine interface may include a voice-input unit and a voice-output unit.

In brief, a flash lamp is externally connected to a portable communication device with photographic function in the present invention. When the surrounding illumination is not strong enough to capture a quality image, the flash lamp provides additional light necessary to capture a good optical image. Hence, environment is no longer a major limitations for taking a good picture using the portable communication device.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram showing the configuration of a portable communication device with an externally connected flash lamp according to a first embodiment of the present invention.

FIG. 2 is a block diagram showing the configuration between the host module and the man-machine interface of the portable communication device according the first embodiment of the present invention.

FIG. 3 is a block diagram showing the configuration of a portable communication device with an externally connected flash lamp according to a second embodiment of the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

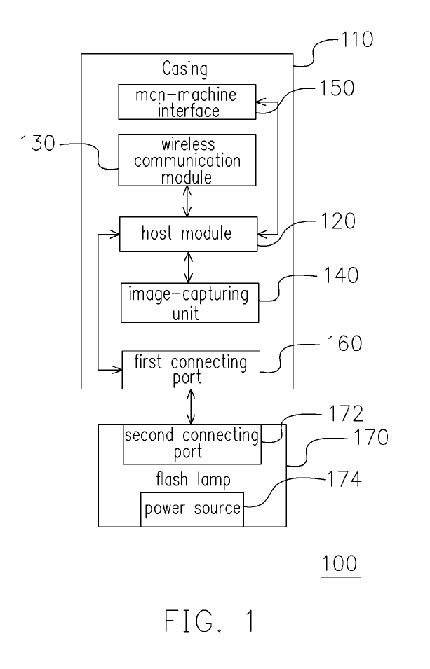

FIG. 1 is a block diagram showing the configuration of a portable communication device with an externally connected flash lamp according to a first embodiment of the present invention. As shown in FIG. 1, the portable communication device 100 essentially comprises a casing 110, a host module 120, a wireless communication module 130, an image-capturing unit 140, a man-machine interface 150, a first connecting port 160 and a flash lamp 170.

The host module 120 is set up inside the casing 110. The host module 120 may include a microprocessor, a memory and a power supply (not shown), for example. The wireless communication module 130 is installed inside the casing 110 and electrically connected to the host module 120. The wireless communication module 130 is used for transmitting and receiving communication signals. The communication may be carried out using a single protocol at a single waveband. In a more sophisticated system, the communication may be carried out automatically by switching between various communication protocols at different wavebands so that different wireless communication signals can be transmitted and received.

The image-capturing unit 140, the man-machine interface 150 and the first connecting port 160 are mounted on the casing 110 and electrically connected to the host module 120. The image-capturing unit 140 is used to capture optical images such as landscape, people and documents. The man-machine interface 150 is used to control the host module 120. The image-capturing unit 140 may comprises a set of lenses and an image-capturing element. The flash lamp 170 has a second connecting port 172 with a removable electrical connection to the first connecting port 160. The flash lamp 170 provides an additional light source to the portable communication device 100. In addition, the flash lamp 170 may include a power source 174 for providing necessary operating power. When the flash lamp 170 has a self-contained power source, power within the portable communication device 100 is conserved so that a shortening of the standby period is prevented.

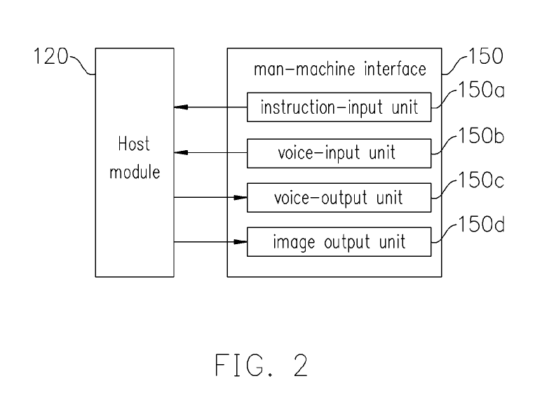

FIG. 2 is a block diagram showing the configuration between the host module and the man-machine interface of the portable communication device according the first embodiment of the present invention. As shown in FIG. 2, the man-machine interface 150 essentially comprises an instruction-input unit 150a and an image output unit 150d. The instruction-input unit 150a may be a digital writing board or a keyboard, and the image output unit 150d may be a liquid crystal display (LCD), an organic electro-luminescent display (OELD) or other flat display. Furthermore, the instruction-input unit 150a and the image output unit 150d can be integrated together to form a touch-control screen that expands the display area and facilitates input. In addition, the man-machine interface 150 may further include a voice-input unit 150b and a voice-output unit 150c. The voice-input unit 150b may be a microphone and the voice-output unit 150c may be a speaker.

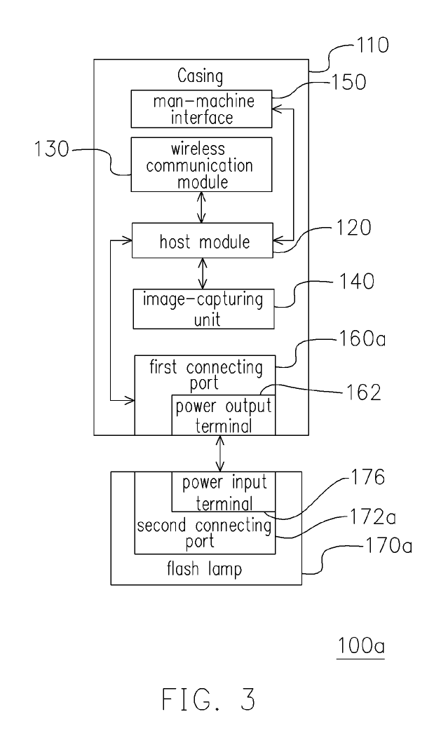

FIG. 3 is a block diagram showing the configuration of a portable communication device with an externally connected flash lamp according to a second embodiment of the present invention. As shown in FIG. 3, the portable communication device 100a differs from the portable communication device 100 of the first embodiment mainly in the design of the first connecting port 160a and the flash lamp 170a. The first connecting port 160a of the portable communication device 100a has a power output terminal 162. The flash lamp 170a has a second connecting port 172a with a removable electrical connection to the first connecting port 160a. In addition, the second connecting port 172a has a power input terminal 176. In this embodiment, the flash lamp 170a obtains power from the portable communication device 100a through the power input terminal 172 of the second connecting port 170a and the power output terminal 162 of the first connecting port 160a. Hence, there is no need to set up an external power source inside the flash lamp 170a.

It should be noted that the externally connected flash lamp need not mount directly onto the casing of the portable communication device. The flash lamp may connect through a flexible cable to the casing of the portable communication device. With this design, the flash lamp can be moved to a suitable location to illuminate an object before a photo of the object are taken. In other words, the portable communication device provides greater imaging flexibility and produces picture having a better image quality.

In summary, the present invention provides an externally connected flash lamp to a portable communication device with photographic function. When the surrounding illumination is not strong enough to capture a quality image, the flash lamp provides an additional light source necessary to capture a good optical image. Hence, environment is no longer a major limitations for taking a good picture using the portable communication device. In the meantime, because the flash lamp is designed to connect externally, there is no increase in the weight or volume of the portable communication device. In addition, the power for driving the flash lamp can be provided by the portable communication device or obtained from a self-contained power source.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A portable communication device, comprising:
a casing;
a host module set up inside the casing;
a wireless communication module set up inside the casing and electrically connected to the host module,
wherein the wireless communication module is used to receive/transmit a communication signal;
an image-capturing unit set up on the casing and electrically connected to the host module, wherein the image-capturing unit is used to capture an optical image;
a man-machine interface set up on the casing and electrically connected to the host module, wherein the man-machine interface is used to control the host module;
a first connecting port set up on the casing and electrically connected to the host module, and
a flash lamp having a second connecting port with a removable electrical connection to the first connecting port and the flash, wherein the flash lamp is an additional light source.

2. The portable communication device of claim 1, wherein the flash lamp further comprises a power source.

3. The portable communication device of claim 1, wherein the first connecting port has a power output terminal and the second connecting port has another power input terminal for contacting the power input terminal of the first connecting port.

4. The portable communication device of claim 1, wherein the man-machine interface comprises an instruction-input unit and an image output unit.

5. The portable communication device of claim 4, wherein the instruction-input unit integrates with the image output unit to form a touch-control screen.

6. The portable communication device of claim 4, wherein the man-machine interface further comprises a voice-input unit and a voice-output unit.
